(19) United States
(12) Patent Application Publication
(10) Pub. No.: US 2015/0130198 A1
(43) Pub. Date: May 14, 2015

(54) FLIPPING HOOK APPARATUS FOR MANIPULATING FOOD ITEMS

(71) Applicant: Teddy Croom, Castle Hayne, NC (US)

(72) Inventor: Teddy Croom, Castle Hayne, NC (US)

(21) Appl. No.: 14/080,697

(22) Filed: Nov. 14, 2013

(51) Int. Cl. A47J 43/28

(52) U.S. Cl. CPC A47J 43/283
USPC 294/26

(57) ABSTRACT

A flipping hook apparatus for allowing a user to reduce the number of cooking utensils needed for a given job, eliminating food dropping, moving a user's hand further away from a heating element while manipulating food, minimizing arm and wrist twisting while manipulating food, and more safely lower food onto cooking surfaces. The flipping hook apparatus comprises a hook member having an elongated shaft and a hook portion permanently attached to an elongated handle. The hook portion is defined by a 90 degree bend in the elongated shaft, followed by a 1 inch diameter roll in a 150 to 160 degree angle. It is contemplated that the hook member is constructed out of stainless steel and the handle is constructed out of wood having up to three coats of polyurethane so as to seal and protect the wood.

### BACKGROUND OF THE INVENTION

1. Field of the Invention

This invention relates generally to cooking utensils and, more particularly, to an apparatus for grasping and flipping food being cooked on a grill or in a pan or otherwise manipulating the same.

2. Description of the Prior Art

The use of cooking utensils, such as a conventional tongs and forks, during the preparation and service of food is well known. While conventional tongs are typically used to grip in a pinching motion in order to grasp food, conventional forks are typically used to pierce in order to grasp food. Though they function differently, they are still used for substantially the same purpose, to grasp food in order to place it or move it while cooking or serving.

A problem which exists with conventional tongs and forks, however, is that many tongs and forks struggle to maintain grasp of heavier food items because of their design or because they are structurally not very sturdy. For example, it is not uncommon for food to slip from the grip of tongs or to slide off a fork. Moreover, standard tongs also typically require a user to rotate their wrists frequently, while maintaining the pinching action, in order to perform basic food manipulation operations, such as flipping. Thus, there remains a need for a flipping hook apparatus which would eliminate the need for a user to pinch food while preparing or serving in order to pick it up or move it. It would be helpful if such a flipping hook apparatus was structured so as to significantly reduce the risk of grasped food slipping off. It would be additionally desirable for such a flipping hook apparatus to be structured to provide additional distance between a user's hand and a heating element when in use.

The Applicant's invention described herein provides for a flipping hook apparatus adapted allow food items to be grasped and manipulated in a secure manner The primary components of Applicant's adjustable extension bar are a hook member and a handle portion. When in operation, the flipping hook apparatus allows a user to pierce food items to be grasped with a curved hook embedded in an elongated solid handle so as to allow the food item to be gripped securely and manipulated without user supplied pinching. As a result, many of the limitations imposed by prior art structures are removed.

### SUMMARY OF THE INVENTION

A flipping hook apparatus for allowing a user to reduce the number of cooking utensils needed for a given job, eliminating food dropping, moving a user's hand further away from a heating element while manipulating food, minimizing arm and wrist twisting while manipulating food, and more safely lower food onto cooking surfaces. The flipping hook apparatus comprises a hook member having an elongated shaft and a hook portion permanently attached to an elongated handle. The hook portion is defined by a 90 degree bend in the elongated shaft, followed by a 1 inch diameter roll in a 150 to 160 degree angle. It is contemplated that the hook member is constructed out of stainless steel and provides a means for securely grasping food items while the handle is constructed out of wood having up to three coats of polyurethane so as to seal and protect the wood and provides a means for manipulating.

It is an object of this invention to provide a flipping hook apparatus which would eliminate the need for a user to pinch food while preparing or serving in order to pick it up or move it.

It is another object of this invention to provide a flipping hook apparatus structured to significantly reduce the risk of grasped food slipping off

It is yet another object of this invention to provide a flipping hook apparatus structured to provide additional distance between a user's hand and a heating element when in use.

These and other objects will be apparent to one of skill in the art.

### BRIEF DESCRIPTION OF THE DRAWINGS

FIG. 1 is a side elevational view in cross section of a flipping hook apparatus built in accordance with the present invention.

FIG. 2 is a front elevational view of the handle of a flipping hook apparatus built in accordance with the present invention

FIG. 3 is a side elevational view of a flipping hook apparatus built in accordance with an alternate embodiment of the present invention.

FIG. 4 is a top plan view in cross section of a flipping hook apparatus built in accordance with the present invention having an attaching strap.

### DETAILED DESCRIPTION OF THE INVENTION

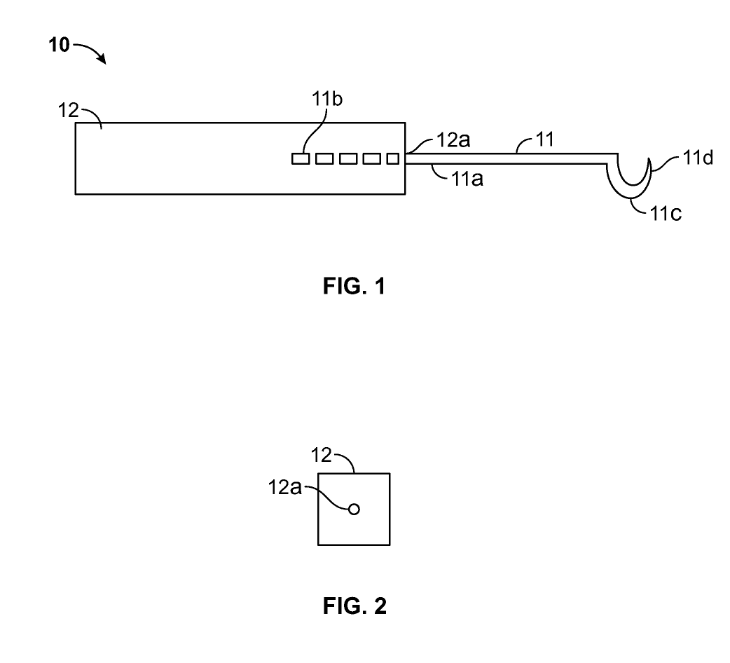

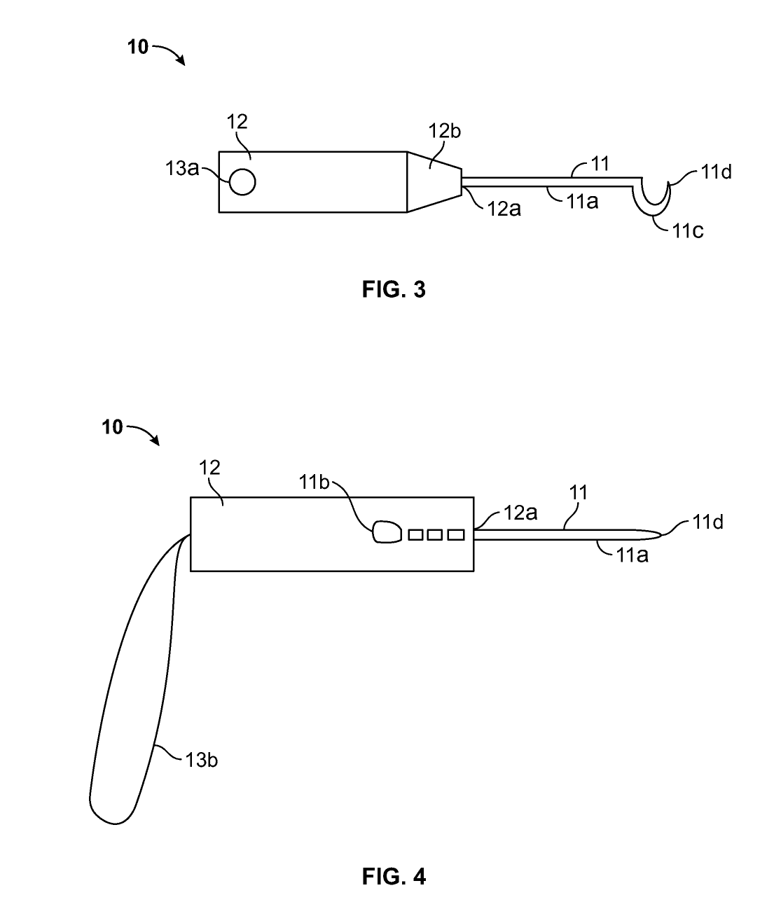

Referring now to the drawings and in particular FIGS. 1, 2, 3, and 4, a flipping hook apparatus 10 is shown having a hook member 11 permanently attached to an elongated handle 12. The hook member 11 is defined by an elongated shaft 11a which has a proximal end 11b and a hook portion 11c disposed about a distal end 11d. The hook portion 11c is defined by a 90 degree bend in the elongated shaft 11a, followed by a 1 inch diameter roll in a 150 to 160 degree angle. It is contemplated that the hook member 11 is constructed out of stainless steel.

The handle 12 is an elongated rectangular body having a wire aperture 12a centrally disposed in its front end which is configured to receive and securely hold the proximal end 11b of the elongated shaft 11a. It is contemplated that the handle 12 is constructed out of wood having up to three coats of polyurethane so as to seal and protect the wood.

The proximal end 11b of elongated shaft 11a is embedded into an the handle 12 to form the assembled flipping hook apparatus 10. To provide for a more secure attachment, the proximal end 11b is defined by a flat tip. This flat tip allows the elongated shaft 11a to bite the wood and also prevents the hook member 11 from twisting while secured in the handle 12.

In one embodiment, the external shape of the handle 12 is defined by an elongated rectangular body which has a tapered portion 12b about its front end so as to improve maneuverability in tighter spaces.

In one embodiment, the handle 12 includes a hanging aperture 13a near its back end a so as to allow the flipping hook apparatus 10 to be hung on an conventional wall hook or other hanging structure. In another embodiment, the handle 12 includes a strap member 13b permanently attached to its back end for assisting in handling of hanging the flipping hook apparatus 10 when it is not in use.

It is contemplated that the flipping hook apparatus can be constructed in various sizes to be directed at differing used. For frying, the handle is 8 inches by 1 inch by 1 inch, with the wire aperture being 0.120″ in diameter and 2¼ inches deep. The hook member is an 8 inch wire having a ⅛ inch diameter, with a sharpened flat proximal end and a hook with a sharpened end point at its distal end. The proximal end is pressed 3 inches into handle. For standard grilling, the handle is 12 inches by 1⅛ inched by 1⅛ inches, with the wire aperture being 0.120″ in diameter and 2¼ inches deep. The hook member is an 12 inch wire having a ⅛ inch diameter, with a sharpened flat proximal end and a hook with a sharpened end point at its distal end. The proximal end is pressed 3 inches into handle. For larger or commercial needs, a 20 inch by 1½ inch by 1½ inch handle, with a larger wire aperture, and a 12 inch wire having a 3/16 to ¼ inch diameter hook member, with a sharpened flat proximal end and a hook with a sharpened end point at its distal end can be used. For the larger embodiment, the proximal end is pressed 6 inches into handle.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A flipping hook apparatus, comprising
a hook member defined by an elongated shaft having a proximal end and a distal end, wherein said distal end is defined by a hook portion;
a handle having an elongated body with a front end and a back end, wherein said front end of said handle includes a wire aperture adapted to receive and securely hold said proximal end of hook member; and
wherein said hook member is permanently attached to said handle by way of the proximal end being permanently disposed in said wire aperture.

2. The flipping hook apparatus of claim 1, wherein said hook portion is defined by a 90 degree bend in the elongated shaft followed by a 1 inch diameter roll in a 150 to 160 degree angle.

3. The flipping hook apparatus of claim 1, wherein said proximal end is defined by a flat tip adapted to prevent hook member from twisting while attached to the handle.

4. The flipping hook apparatus of claim 1, wherein the elongated body of handle is rectangular so as to improve ergonomics.

5. The flipping hook apparatus of claim 1, wherein the elongated body of handle is cylindrical so as to improve ergonomics.

6. The flipping hook apparatus of claim 1, wherein at least a third of the length of the elongated shaft is disposed in said wire aperture.

7. The flipping hook apparatus of claim 1, wherein at least a half of the length of the elongated shaft is disposed in said wire aperture.

8. The flipping hook apparatus of claim 1, wherein the external shape of the handle includes a tapered portion about its front end.

9. The flipping hook apparatus of claim 1, additionally comprising a strap member permanently attached to the back end of said handle.

10. A flipping hook apparatus, comprising
a means for securely grasping food items;
a means for manipulating; and
wherein said means for securely grasping is permanently attached to said means for manipulating.
